(19) United States
(12) Patent Application Publication
(10) Pub. No.: US 2020/0406067 A1
(43) Pub. Date: Dec. 31, 2020

(54) Reapplying Sunblock Calculator

(71) Applicant: Walker Brandt, New York, NY (US)

(72) Inventor: Walker Brandt, New York, NY (US)

(21) Appl. No.: 16/453,810

(22) Filed: Jun. 26, 2019

(51) Int. Cl. A61Q 17/04; G06F 9/54; G06T 7/90; G06F 3/0482

(52) U.S. Cl. CPC A61Q 17/04; G06F 3/0482; G06T 7/90; G06F 9/542

(57) ABSTRACT

A method that may be executed by a device for calculating a reapplication time for sunscreen. The method may be implemented as lines of code that are executed by the device. The method includes receiving information associated with a reapplication of sunscreen, calculating the reapplication time for the sunscreen based, in part, on the information and displaying the reapplication time to a user.

### FIELD

The present disclosure relates to calculating when to reapply sunscreen after sunscreen has been applied to the skin. More particularly, the invention relates to a calculator applied to the practical application of aiding a user to understand when to reapply sunscreen to prevent sunburn.

### BACKGROUND INFORMATION

Generally, when exposed to sunlight, a person is vulnerable to sunburn. A sunburn is a result of overexposure to ultraviolet radiation, which comes from sunlight. This overexposure causes a radiation burn (i.e., sunburn) which affects living tissue including damaging the DNA of skin cells. This damage can have immediate effects such as pain and burning in the affected areas. However, it may also have long term effects such as increasing the risk of skin cancer, such as tumors, moles, melanoma, etc. It has been shown that sunburns in childhood and adolescence may increase the risk of developing melanoma later in life.

Sunscreen can prevent sunburn; however, many users do not know when to reapply sunscreen so their skin remains protected. Thus, there is a need for a calculator that estimates when a user should reapply sunscreen.

### SUMMARY

In an exemplary embodiment, a non-transitory computer-readable storage medium including a set of instructions executable by a processor is described. The set of instructions, when executed by the processor, cause the processor to perform operations. The operations include receiving information associated with a reapplication of sunscreen, calculating a reapplication time for the sunscreen based, in part, on the information and displaying the reapplication time to a user.

In a further exemplary embodiment, a method for calculating a reapplication time for sunscreen is described. The method includes receiving information associated with a reapplication of sunscreen, calculating the reapplication time for the sunscreen based, in part, on the information and displaying the reapplication time to a user.

In another exemplary embodiment, a device having a processor and a display is described. The processor is configured to receive information associated with a reapplication of sunscreen and calculate a reapplication time for the sunscreen based, in part, on the information. The display is configured to display the reapplication time to a user.

### BRIEF DESCRIPTION OF THE DRAWINGS

FIG. 1 shows an exemplary embodiment of the gender and age screen of the reapplying sunblock calculator according to various embodiments described herein.

FIG. 2 shows an exemplary embodiment of the sunscreen screen of the reapplying sunblock calculator according to various embodiments described herein.

FIG. 3 shows an exemplary embodiment of the sunblock screen of the reapplying sunblock calculator according to various embodiments described herein.

FIG. 4 shows an exemplary embodiment of the temperature screen of the reapplying sunblock calculator according to various embodiments described herein.

FIG. 5 shows an exemplary embodiment of the skin condition screen of the reapplying sunblock calculator according to various embodiments described herein.

FIG. 6 shows an exemplary embodiment of the output screen of the reapplying sunscreen calculator according to various embodiments described herein.

FIG. 7 shows an exemplary embodiment of a device executing the reapplying sunblock calculator.

### DETAILED DESCRIPTION

The exemplary embodiments may be further understood with reference to the following description and the appended drawings, wherein like elements are referred to with the same reference numerals. The exemplary embodiments describe an application that calculates when to reapply sunscreen. The application considers various factors such as a user's gender, age, skin tone, any skin conditions, the type of sunscreen being applied, and the environmental conditions surrounding the user. The exemplary reapplying sunblock calculator may prevent the common problem of sunburn. The exemplary reapplying sunscreen calculator is shown as a mobile application. However, it should be understood that this method of calculation can be used on many different platforms and is not limited to mobile applications.

The calculator provides a unique solution to the practical problem of avoiding sunburn. There is no manual manner of accounting for the various factors that need to be accounted for as to when to reapply sunscreen. That is, it is impractical for a person who is outdoors (e.g., at the beach, at the park, etc.) to determine in a manual manner when to reapply sunscreen. The exemplary embodiments solve this issue by allowing a user of the calculator to know when sunscreen should be reapplied using only the calculator and some basic information that may be entered by the user or collected by the device that executes the calculator (e.g., a mobile phone).

Throughout this description, there terms “calculator” and “application” may be used interchangeably to describe the exemplary embodiments. As described above, the exemplary embodiments are intended to be executed as an application on a user's mobile device so the user may understand when sunscreen should be reapplied. However, those skilled in the art will understand that there may be other manners of using the exemplary embodiments. In a first alternative, a store that sells sunscreen (e.g., a pharmacy) may have a stationary device that runs the calculator so a buyer at the store may enter information and receive times at which sunscreen should be reapplied. In a second alternative, a sunscreen company may set up a kiosk in a location (e.g., the beach) where users may enter information to understand when they should reapply sunscreen.

In addition, throughout this description the terms “sunscreen” and “sunblock” are used interchangeably to describe a lotion, spray, gel, foam, stick, cream or other topical product applied to the skin to protect the skin from the sun and prevent sunburn. Furthermore, the term “reapplication” is used to describe a user reapplying the sunscreen or sunblock and it is not related to the term “application” as that term is used to describe the calculator. The term reapplication is used because the exemplary embodiments assume that a user will initially apply the sunscreen before or immediately upon going outdoors into the sun. There is no need to calculate this initial applying of the sunscreen because the user should know it is to occur before or immediately upon going outdoors into the sun.

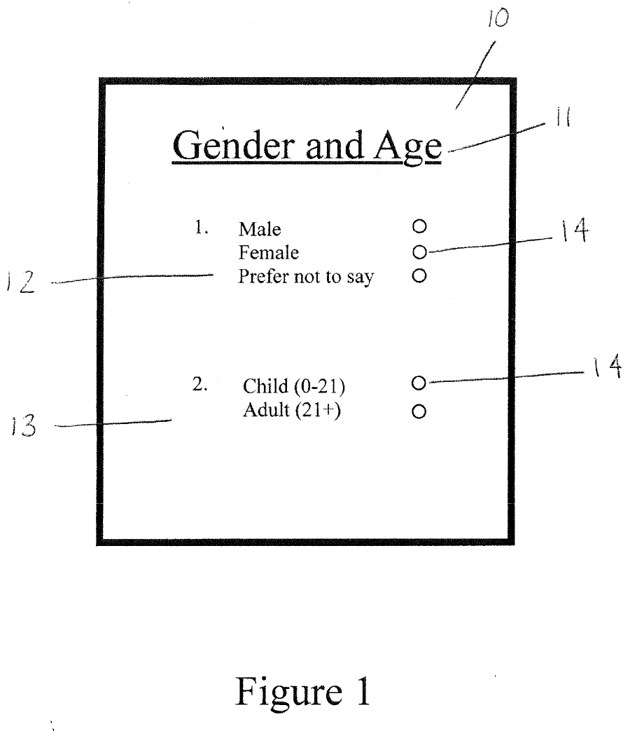

FIG. 1 shows an exemplary embodiment of the gender and age screen 10 of the reapplying sunblock calculator. The gender and age screen 10 of the reapplying sunblock calculator is comprised of a title 11, a gender input 12, an age input 13, and selection buttons 14 for each input. The user may use the selection buttons 14 for the gender input 12 and for the age input 13. In the exemplary embodiment, the selection buttons 14 are shown as radio buttons so the user may select only one option each for the gender input 12 and age input 13. However, it should be noted that checkboxes, list boxes, dropdown lists, or buttons may be used in lieu of radio buttons. In one example, the gender 12 and age input 13 may be inputted through the use of a text field where the user types in the desired information. The method of obtaining the gender input 12 and the age input 13 from the user is not inclusive of what is shown in the exemplary embodiment.

The exemplary embodiment shows the title 11 as “Gender and Age,” but it should be noted that the title 11 could say anything relevant to the information being requested on the gender and age screen 10. In certain embodiments the gender and age screen 10 may be split into two screens asking for the gender input 12 on one screen and the age input 13 on another screen.

In certain embodiments, the gender input 12 and the age input 13 may be comprised of different options than the options shown in the exemplary embodiment or may be abbreviations of options. In one example, the gender input 12 may read “F” and “M.” In another example, the age input 13 may include several age ranges, enabling the user to choose a more specified range for his or her age.

Thus, it should be understood that gender and/or age information that is entered on the gender and age screen 10 may be information that is used to perform a calculation to determine when the user should reapply sunscreen.

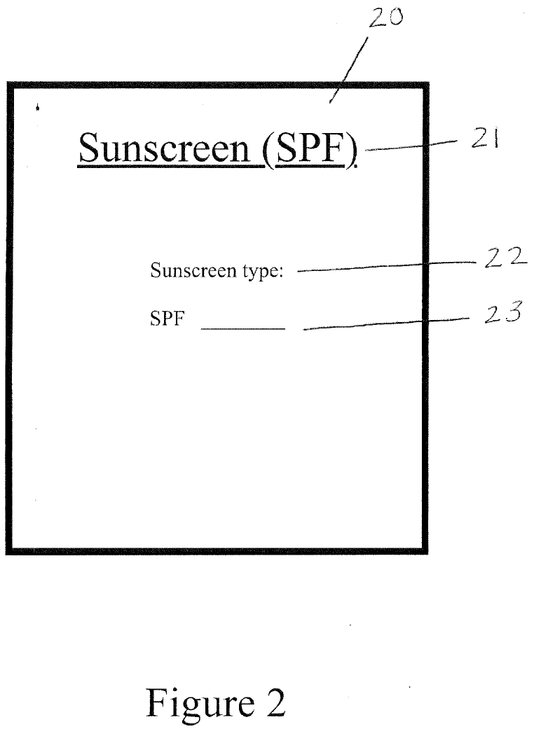

FIG. 2 shows an exemplary embodiment of the sunscreen screen 20 of the reapplying sunblock calculator. The sunscreen screen 20 is comprised of a title 21, a sunscreen input 22, and a sunscreen text field 23. The user may type the SPF of the sunscreen they are using into the sunscreen text field 23. In the exemplary embodiment, the use of a sunscreen text field 23 is shown, however it should be noted that other forms of user input controls may be used to obtain this information from the user. For example, a dropdown list or a list box may be used to allow the user to choose a sunscreen SPF from a list of options. In one exemplary embodiment, a maker of sunscreens may pre-populate its different lines of sunscreens into the application so a user may select the particular type of sunscreen that the user has purchased (e.g., a trade name of the sunscreen).

The exemplary embodiment shows the title 21 as “Sunscreen (SPF),” but it should be noted that the title 21 could say anything relevant to the information being requested on the sunscreen screen 20. “SPF,” as displayed in the exemplary embodiment, is defined as Sun Protection Factor. However, the reapplying sunscreen calculator is not restricted to only SPF protection, but also to a UV protection rating (UVA, UVB, etc.). In another example, an ingredient(s) of the sunscreen such as ecamsule, avpbenzone, titanium dioxide, zinc oxide, etc. may be input. In a further example, one or more properties of the sunscreen such as water and sweat resistant sunscreens, kid-friendly sunscreens, etc. may be input. In a still further example, a form of the sunscreen such as lotion, spray, gel, foam, stick, cream, etc. may be input. All of these examples may be termed as types of sunscreens or sunscreen type information. Thus, the sunscreen input 22 may be adapted to receive one or more of these sunscreen type inputs, as applicable.

Similar to the gender/age information described above, the sunscreen type may be information that is used to perform a calculation to determine when the user should reapply sunscreen.

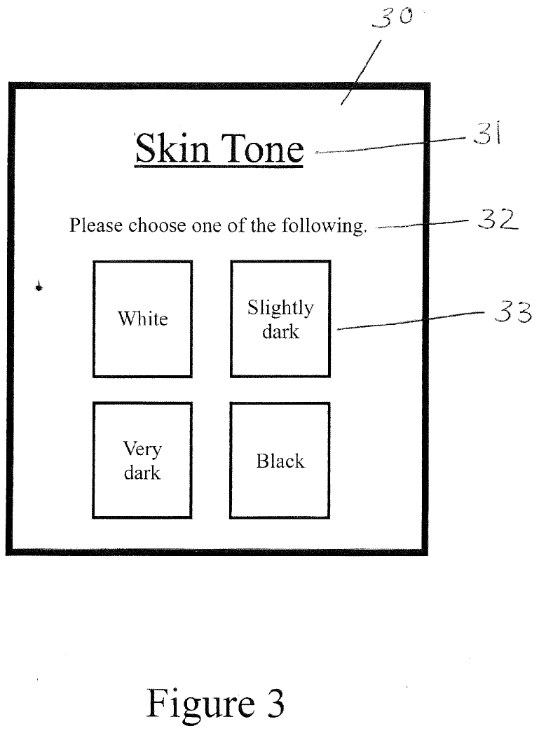

FIG. 3 shows an exemplary embodiment of the skin tone screen 30 of the reapplying sunblock calculator. The skin tone screen 30 is comprised of a title 31, a skin tone input 32, and skin tone selection buttons 33. The skin tone screen 30 displays a title 31 that states “skin tone,” however, it should be noted that the title 31 could say anything relevant to the information being requested on the skin tone screen 30.

The skin tone input 31 asks a user to select one of the following options in the form of skin tone selection buttons 33. The skin tone selection buttons 33 have options the user may choose so they can select the description that best describes their skin tone. In certain embodiments, the skin tone input 32 will offer four skin tone selection buttons 33. In other embodiments, the skin tone input 30 will offer more than four skin tone selection buttons 33, making the skin tone options more specific.

In certain embodiments, the skin tone selection buttons 33 will be in the form of buttons which will take the user to the next screen upon selection. In the exemplary embodiment, the skin tone selection buttons 33 are labeled using text describing different skin tones. In another example, the skin tone selection buttons 33 may be labeled using the actual color of the skin tone that the user wants to select. In certain embodiments, the skin tone selection buttons 33 may be in the form of radio buttons, check boxes, a text field, a list box, a dropdown list, or any other user input control.

In another exemplary embodiment, the user may use functionality of the mobile device on which the application is running to enter the user's skin tone. For example, the user may take a picture of themselves or a particular body part with the camera of the mobile device. The calculator may analyze the photograph to determine the skin tone of the person. Again, similar to the gender/age and sunscreen type information described above, the user's skin tone may be information that is used to perform a calculation to determine when the user should reapply sunscreen.

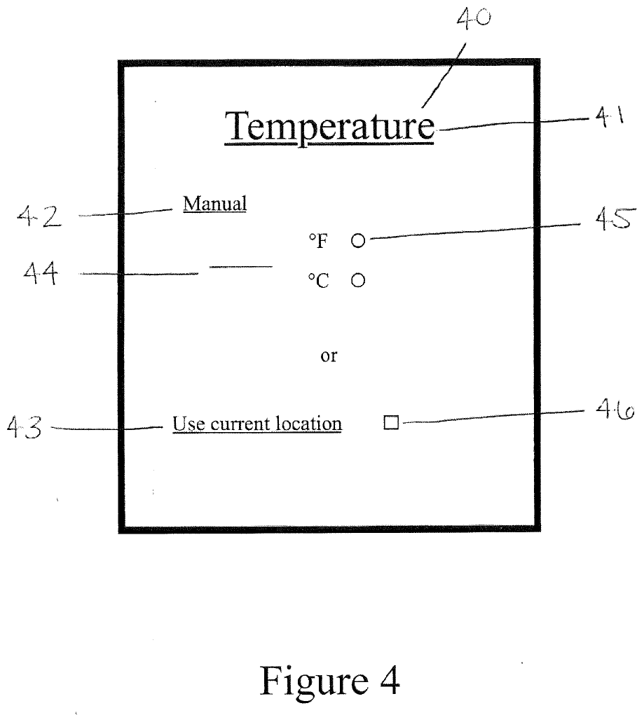

FIG. 4 shows an exemplary embodiment of the temperature screen 40 of the reapplying sunblock calculator. The temperature screen 40 is comprised of a title 41, a manual temperature input 42, a current location input 43, a manual temperature text field 44, manual temperature selection buttons 45, and a current location selection button 46. The temperature screen 40 displays a title 41 that states “Temperature,” however, it should be noted that the title 41 could say anything relevant to the information being requested on the temperature screen 40.

In the exemplary embodiment, the manual temperature input 42 allows the user to type the current temperature into the manual temperature text field 44 and then choose whether that temperature is in degrees Fahrenheit or degrees Celsius with the manual temperature selection buttons 45. In other embodiments, the manual temperature input 42 may be in the form of other user input controls. For example, a list box or dropdown list with several temperatures for the user to choose from. In another example, the manual temperature input 42 gives temperature ranges as options for the user to choose.

In the exemplary embodiment, the current location input 43 allows the user to select the current location selection button 46 so that the user's GPS will gather the relevant information for the user in lieu of manually inputting the requested information. A user may choose to either manually input the requested information or to allow the system to access his or her GPS location to gather the requested data. For example, once the GPS coordinates are determined, the calculator may access further information such as local weather services to determine the weather at the GPS location. If the mobile device is not equipped with a GPS chip, the user may enter a zip code or city/state information that the calculator may then use to retrieve current weather conditions. In one example, the calculator may access an external information source for the weather information such as contacting a weather website. In another example, the calculator may receive the weather information from another application on the device executing the calculator (e.g., the device may be executing a weather application such as The Weather Channel, AccuWeather, Dark Skies, etc.

The temperature screen 40 reflects the use of the environmental conditions surrounding the user. The use of temperature in the exemplary embodiment is not meant to limit the reapplying sunblock calculator to only the use of temperature. For example, other weather or environmental related factors such as humidity, time of day, air temperature and pressure, location, cloud coverage and type, precipitation type, wind speed and direction, UV ray strength, etc. may also be used to determine when a user should reapply sunscreen. In another exemplary embodiment, time of day may also be used in the calculation (e.g., a different calculation may be used early in the afternoon as opposed to when sunset is approaching). Furthermore, the calculator may also use weather information in the form of forecast information in the calculation. For example, it may currently be cloudy, but the forecast may be for the clouds to dissipate. This may lead to a different calculation of when to reapply the sunscreen than if it is forecast to remain cloudy.

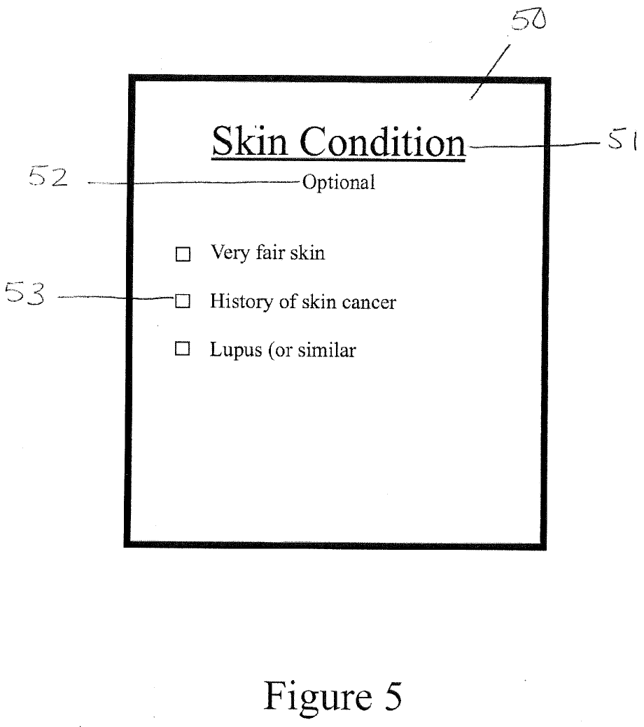

FIG. 5 shows an exemplary embodiment of the skin condition screen 50 of the reapplying sunblock calculator. The skin condition screen 50 is comprised of a title 51, a skin condition input 52 and skin condition selection buttons 53. The skin condition screen 50 displays a title 51 that states “Skin Condition,” however, it should be noted that the title 51 could say anything relevant to the information being requested on the skin condition screen 50. The skin condition input 52 displays the word “optional,” as this information may not be necessary for all users to provide. However, in other embodiments, the requested information may not be optional and the skin condition input 52 will display alternative instructions.

In the exemplary embodiments, the skin condition screen 50 allows a user to choose from multiple skin condition selection buttons 53 that describe various skin conditions. In some embodiments, the user may choose multiple skin condition selection buttons 53 through the use of checkboxes, list boxes, or other similar user input controls. In other embodiments, the user may choose only one skin condition selection button 53 through the use radio buttons, dropdown lists, or other similar user input controls. The skin condition selection buttons 53 may reflect many skin conditions and it should be understood that the skin condition selection buttons 53 are not limited to those shown in the exemplary embodiment.

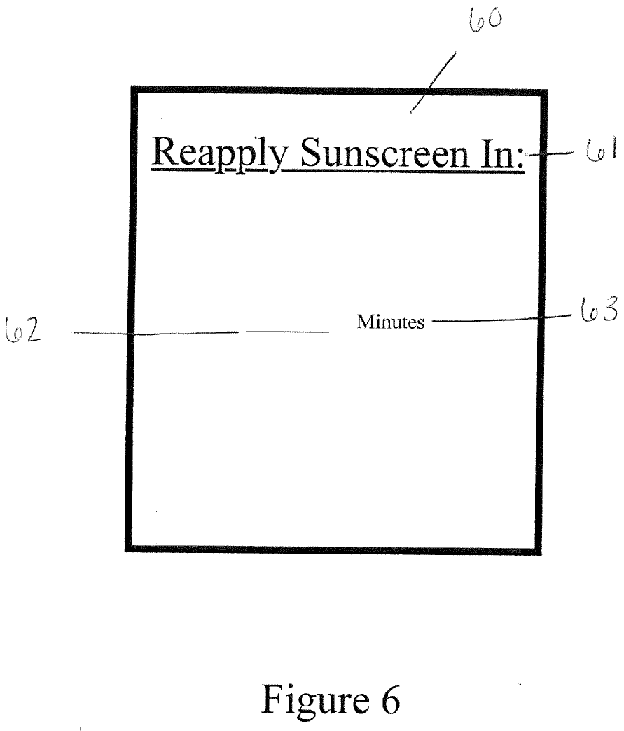

FIG. 6 shows an exemplary embodiment of the output screen 60 of the reapplying sunblock calculator. The output screen 60 is comprised of a title 61, an output population field 62, and output units 63. The output screen 60 displays a title 61 that states “Reapply Sunscreen in,” however it should be noted that the title 61 could say anything relevant to the information being outputted out the output screen 60.

Once the user has provided the desired information on every screen of the reapplying sunblock calculator as described above, the reapplying sunblock calculator will output a time in the output population field 62 in which the user should reapply sunscreen. The output units 63 are shown in minutes, however any unit of time may be used and is not limited to the units shown in the exemplary embodiment. However, the output population field 62 is not limited to an amount of time a user has to reapply sunscreen. In one example, the output population field 62 provides a time of day that the user should reapply sunscreen and the output units 63 would display “A.M.” or P.M.”

The calculation of the reapplication time is not limited to any particular algorithm or formula. That is, depending on the information that is provided to the calculator, the calculator may use the information in various manners to determine the reapplication time. For example, the calculator may store various tables that relate one or more factors to reapplication times and the information from these tables may be used to determine the reapplication time based on the multiple factors input by the user. The different tables (or values derived from the tables) may be prioritized based on a relative importance of different factors. In another example, the different factors may be represented in a formula that results in the output of the reapplication time. Each factor may correlate to a reapplication time and the formula may mathematically combine the different factors to result in the overall reapplication time, e.g., summation, integration, statistical combination, etc. In one example, a sunscreen company may have different formulas (proprietary or nonproprietary) for the different types of sunscreen that they sell and these formulas may be loaded into the calculator and then used based on the user's selection of the sunscreen type.

It should be noted that any of the example information that has been provided above as inputs may be input optionally. That is, the user may skip one or more of the inputs and a reapplication time may still be calculated and provided to the user. However, those of skill in the art will understand that more information generally results in a more accurate calculation of the reapplication time. Moreover, as stated above, the described information is only exemplary. Other information may be used by the reapplying sunblock calculator. Other examples of information that may be used include, eye color, hair color, if the subject has a history of getting sunburned, if the subject had regularly exposed their unprotected skin to UV rays from sunlight or artificial sources, if the subject uses photosensitizing medication, etc.

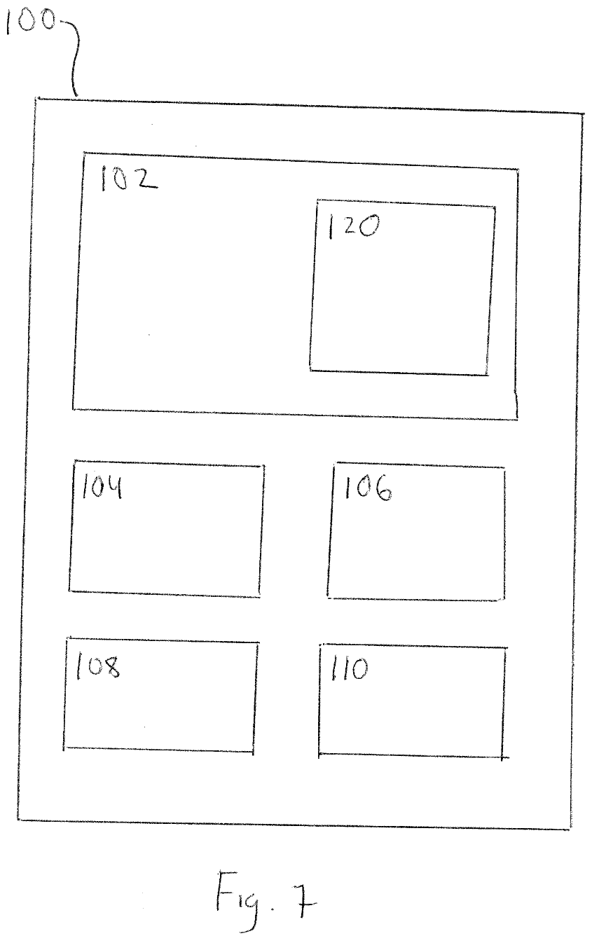

FIG. 7 shows an exemplary embodiment of a device 100 executing the reapplying sunblock calculator. The device 100 may be any type of mobile device such as a smartphone, a tablet computer, a laptop computer, a wearable device (e.g., watch), an Internet of Things (IoT) device, etc. The device 100 comprises a processor 102, a memory 104, a transceiver 106, a user interface 108, and a display 110. Those skilled in the art will understand that the device 100 may also include other components. The processor 102 may execute the reapplying sunblock calculator 120. Those skilled in the art will understand that the reapplying sunblock calculator 120 may be implemented by the processor 102 as, for example, lines of code that are executed by the processor 102, as firmware executed by the processor 102, as a function of the processor 102 being an application specific integrated circuit (ASIC), etc.

The memory 104 may include, for example, the tables described above. The transceiver 106 may be used to communicate with other devices or data sources, e.g., the weather site. The user interface 108 may be an input device such as a keyboard, mouse, touchscreen, etc. The user may use the user interface 108 to enter the various information described above. The display 110 may be used to display the screens described above with reference to FIGS. 1-6.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A non-transitory computer-readable storage medium including a set of instructions executable by a processor, the set of instructions, when executed by the processor, causing the processor to perform operations, comprising:
receiving information associated with a reapplication of sunscreen;
calculating a reapplication time for the sunscreen based, in part, on the information; and
displaying the reapplication time to a user.

2. The non-transitory computer-readable storage medium of claim 1, wherein the receiving information comprises receiving input from a user.

3. The non-transitory computer-readable storage medium of claim 1, wherein the receiving information comprises receiving input from one of a further application or an external data source.

4. The non-transitory computer-readable storage medium of claim 1, wherein the information includes a range of information.

5. The non-transitory computer-readable storage medium of claim 1, wherein the information comprises one of gender information, age information, sunscreen type information, skin tone information, weather information, and skin condition information.

6. The non-transitory computer-readable storage medium of claim 5, wherein the sunscreen type information includes one of a sun protection factor (SPF) of the sunscreen, a UV protection rating of the sunscreen, an ingredient of the sunscreen, a property of the sunscreen, a form of the sunscreen or a trade name of the sunscreen.

7. The non-transitory computer-readable storage medium of claim 5, wherein the operations further comprise:
receiving a photograph of the user, wherein the photograph includes a body part of the user to which the sunscreen is to be reapplied; and
determining the skin tone information from the photograph.

8. The non-transitory computer-readable storage medium of claim 1, wherein the information used to calculate the reapplication time comprises at least two of gender information, age information, sunscreen type information, skin tone information, weather information, or skin condition information.

9. The non-transitory computer-readable storage medium of claim 1, further comprising:
one or more tables including a correlation between the information and reapplication information for the sunscreen, wherein calculating the reapplication time for the sunscreen is based on the reapplication information.

10. The non-transitory computer-readable storage medium of claim 1, wherein the calculating the reapplication time for the sunscreen comprises using a formula that correlates the information to the reapplication time.

11. A method for calculating a reapplication time for sunscreen, comprising:
receiving information associated with a reapplication of sunscreen;
calculating the reapplication time for the sunscreen based, in part, on the information; and
displaying the reapplication time to a user.

12. The method of claim 11, wherein the receiving information comprises one of receiving input from a user, receiving input from a further application or receiving input from an external data source.

13. The method of claim 11, wherein the information comprises one of gender information, age information, sunscreen type information, skin tone information, weather information, and skin condition information.

14. The method of claim 13, wherein the sunscreen type information includes one of a sun protection factor (SPF) of the sunscreen, a UV protection rating of the sunscreen, an ingredient of the sunscreen, a property of the sunscreen, a form of the sunscreen or a trade name of the sunscreen.

15. The method of claim 13, further comprising:
receiving a photograph of the user, wherein the photograph includes a body part of the user to which the sunscreen is to be reapplied; and
determining the skin tone information from the photograph.

16. The method of claim 11, wherein the information used to calculate the reapplication time comprises at least two of gender information, age information, sunscreen type information, skin tone information, weather information, or skin condition information.

17. The method of claim 11, wherein calculating the reapplication time for the sunscreen comprises:
correlating, based on one or more stored tables, the information to reapplication information for the sunscreen.

18. The method of claim 11, wherein calculating the reapplication time for the sunscreen comprises:
using a formula that correlates the information to the reapplication time.

19. A device, comprising:
a processor configured to receive information associated with a reapplication of sunscreen and calculate a reapplication time for the sunscreen based, in part, on the information; and
a display configured to display the reapplication time to a user.

20. The device of claim 19, wherein the information comprises one of gender information, age information, sunscreen type information, skin tone information, weather information, and skin condition information.
